(19) United States
(12) Patent Application Publication
(10) Pub. No.: US 2025/0273081 A1
(43) Pub. Date: Aug. 28, 2025

(54) Artificial Intelligence based Speech and Language Therapy and Language Learning which utilizes Facial Recognition, Voice Recognition and Character Avatars

(71) Applicant: Syed Ahad Ali, Chantilly, VA (US)

(72) Inventor: Syed Ahad Ali, Chantilly, VA (US)

(21) Appl. No.: 18/827,684

(22) Filed: Sep. 7, 2024

Related U.S. Application Data
(60) Provisional application No. 63/536,935, filed on Sep. 7, 2023.

(51) Int. Cl. G09B 5/06; G06T 7/246; G06T 13/00; G10L 15/00; G10L 15/18; G10L 25/57

(52) U.S. Cl. CPC G09B 5/06; G06T 7/246; G06T 13/00; G10L 15/005; G10L 15/18; G10L 25/57; G06T 2207/10016; G06T 2207/20084; G06T 2207/30201

(57) ABSTRACT

The invention provides an AI-powered speech, language therapy, and language learning system that utilizes Natural Language Processing (NLP), Convolutional Neural Networks (CNNs), and Generative Adversarial Networks (GANs) to deliver personalized, real-time therapy and learning for individuals with speech disorders or those seeking to improve language proficiency. The system analyzes user speech, language comprehension, and facial expressions, providing immediate feedback on pronunciation, fluency, articulation, and sentence structure. A GAN-generated avatar interacts with the user, mimicking human expressions and offering dynamic, engaging sessions. The platform adapts exercises based on user performance using personalized algorithms to ensure continuous progress. Additionally, it securely stores user data in compliance with privacy regulations, making it accessible through web and mobile platforms. This invention improves upon existing speech therapy and language learning solutions by integrating real-time visual and auditory feedback with AI-driven personalization, offering a more immersive and effective experience.

This non-provisional patent application is filed while asserting priority based on the U.S. application No. 63/536,935.

### TECHNICAL FIELD OF INVENTION

The present invention relates to the field of speech and language therapy and, more particularly, to systems and methods employing artificial intelligence (AI), including Natural Language Processing (NLP), Convolutional Neural Networks (CNNs), and Generative Adversarial Networks (GANs), for providing personalized, real-time therapy and language learning. The invention is designed to assess and improve speech disorders such as articulation issues, stammering, fluency disorders, and voice problems. By leveraging AI-driven technologies, the invention provides dynamic feedback, interactive avatars, and adaptive therapy plans, creating a more engaging and effective therapeutic experience. Additionally, the invention relates to the use of secure cloud-based data storage systems that enable progress tracking and compliance with privacy standards, such as HIPAA, in delivering therapy through mobile and web-based platforms.

### BACKGROUND OF THE INVENTION

### Overview

In recent years, there has been a growing need for accessible and effective speech therapy solutions, particularly for individuals with limited access to specialized care or those constrained by financial and geographical barriers. Conventional speech therapy often requires in-person sessions with trained professionals, which may not be feasible for all individuals. To address these challenges, there is a need for a platform that offers flexible, accessible, and personalized speech therapy and language learning.

This invention relates to a platform that utilizes advanced Artificial Intelligence (AI) technologies, including facial recognition and speech recognition, to provide an innovative solution for speech therapy and language learning. The platform offers interactive and personalized therapy sessions that replicate real-life interactions with a speech therapist, allowing users to engage in targeted and individualized therapy. By analyzing each user's specific speech patterns and needs, the platform generates customized therapy strategies designed to facilitate continuous improvement.

The platform aims to bridge the accessibility gap for those unable to obtain traditional speech therapy services, such as individuals living in remote areas or facing financial limitations. Furthermore, it provides a convenient, virtual alternative for users seeking a flexible, self-paced approach to speech therapy and communication skills enhancement. Ultimately, this invention seeks to remove communication barriers and democratize access to quality speech therapy.

### Patent Classification

a. Class 704: Data Processing: Speech Signal Processing, Linguistics, Language Translation, and Audio Compression/Decompression
b. Class 706: Data Processing-Artificial Intelligence
c. Class 434: Education and Demonstration
d. Class 345: Computer Graphics Processing and Selective Visual Display Systems
e. Class 382: Image Analysis

### Patent Subject Matter

a. Speech recognition
b. Artificial intelligence
c. Machine learning
d. Speech therapy
e. Language learning
f. Real-time feedback
g. Remote monitoring
h. Personalized therapy

### Intended Audience:

Primarily the invention targets:
a. Individuals with Speech Disorders:
   i. Stammering
   ii. Articulation
   iii. Voice Disorder
   iv. Receptive Language Disorder
   V. Expressive Language Disorder
b. Children with Developmental Delays: Early intervention can make a significant difference. Parents of children who show signs of speech or language development delays can use the platform to aid their child's progress.
c. Adults Seeking Accent Reduction: Those wanting to reduce or modify their regional or foreign accents for personal or professional reasons can benefit from the tailored exercises the platform provides.
d. Stroke Survivors, Traumatic Brain Injury and Cognitive Impairment Patients: Individuals who've lost certain speech capabilities due to medical conditions can leverage the platform to regain their communication skills.
e. Educational Institutions: Schools or colleges can incorporate the platform into their special education departments, assisting students who might benefit from speech therapy.
f. Remote or Underserved Communities: In areas where access to traditional speech therapy services is limited or unavailable, residents can use this platform as an alternative.
g. Self-learners: Anyone interested in improving or refining their speech and oral motor skills for personal growth or professional development.

### Relevant Research and Studies:

a. AI-Powered Speech Coaching Tools: These tools provide real-time feedback on speech, analyzing word choice, delivery, and other factors to offer improvement suggestions. Some also incorporate interactive games to make speech improvement more engaging for users.
b. Classroom AI Observation and Personalized Lesson Planning: AI systems are being developed to observe children's speech and behavior in classrooms, collecting data to monitor language processing abilities. Another AI-based application helps speech-language pathologists manage large caseloads by providing personalized lesson plans and ongoing student progress tracking.
c. Speech Motor Training with AI: AI-based speech training systems are designed to assist in improving pronunciation of specific sounds, starting with commonly problematic ones. These systems offer real-time feedback and provide visual aids, such as tongue-position animations, to help users improve their pronunciation.
d. Digital Speech Development Tools: AI-driven speech tools are used to diagnose specific speech issues in children and recommend targeted exercises to address these issues. These tools adapt to users' improvement over time, offering increasingly challenging exercises as users' skills progress.
e. AI-Enhanced Speech Therapy for Children: AI-based systems designed for children use video games to encourage home practice of speech therapy exercises, providing customized word lists and real-time feedback to improve pronunciation and speech patterns.
f. Speech Therapy Customization and Monitoring Tools: Digital speech therapy platforms allow for tailored speech practice with features such as sound customization, difficulty adjustments, and remote progress monitoring by speech-language pathologists.
g. Mobile Apps for Speech and Language Disorders: AI-powered mobile applications facilitate phone-based speech therapy, providing a controlled environment for individuals with speech or language disorders to practice conversational skills. These apps often feature speech-to-text and text-to-speech technology to assist users.
h. Text-to-Speech (TTS) Avatar Technologies: AI-generated avatars convert written text into human-like speech and can be customized for various applications. These technologies are increasingly being used in education, communication, and therapeutic applications.
i. Avatar Therapy for Speech Disorders: AI-based avatar systems are used in therapy sessions, allowing users to engage in dialogues with customizable avatars. This technology helps create a more immersive and controlled therapeutic environment.
j. AI-Generated Video Platforms: AI tools that generate videos from audio inputs are being integrated into educational and corporate training environments, offering personalized media creation for various use cases, including speech therapy.
k. Telehealth Tools for Speech Therapy: Telehealth platforms utilizing live avatars and video conferencing are being developed to support speech therapy, particularly for children with developmental or cognitive disorders. These tools also allow for parental involvement and remote sessions.

### Key Findings and Trends:

a. Real-time Speech Feedback: Many AI-driven speech tools provide real-time feedback on speech patterns, helping users improve their speech dynamically during practice sessions.
b. Gamification of Speech Therapy: Incorporating game elements into speech therapy has proven effective in engaging users, particularly children, making the therapy process more enjoyable and motivating.
c. Personalization and Adaptive Learning: AI technologies are being widely used to tailor speech therapy sessions to individual needs, adjusting the complexity and content of exercises as users make progress.
d. Remote Accessibility: AI-powered tools are expanding access to speech therapy, particularly for individuals in remote or underserved areas. Remote monitoring and progress tracking enable speech-language pathologists to oversee therapy without in-person visits.
e. Support for Speech-Language Pathologists: AI systems are being developed to assist speech-language pathologists in managing large caseloads by providing personalized content recommendations and tracking student progress.
f. Avatar and AI Integration in Therapy: AI-generated avatars and voice models are increasingly used to create interactive, customized therapy sessions, providing a unique approach to speech therapy, particularly for users with anxiety or other barriers to traditional therapy.

The background research highlights the rapidly advancing role of AI in speech therapy and communication improvement, forming the foundation for this invention. The synthesis of key findings informs the invention's goals, methodologies, and the unique contribution it aims to offer in addressing speech disorders and enhancing communication skills. By leveraging AI-driven personalization, real-time feedback, and accessibility solutions, this invention is positioned to redefine the landscape of speech therapy and language learning, providing innovative, adaptive, and remote care to a broad audience.

### BRIEF SUMMARY OF INVENTION

The present invention relates to an artificial intelligence (AI)-driven system designed to deliver personalized and adaptive speech therapy and language learning solutions. The system utilizes AI technologies, including speech recognition, machine learning, and facial recognition, to analyze user speech patterns, diagnose communication disorders, and provide real-time feedback through customized therapy sessions. It is aimed at addressing a wide range of speech disorders, including stammering, articulation issues, voice disorders, receptive and expressive language disorders, and accent modification. Additionally, it offers support for individuals recovering from speech impairments caused by medical conditions such as strokes or traumatic brain injuries.

The invention offers several key advantages:
1. Personalization: The AI system tailors therapy sessions to each user's unique speech patterns and progress. The exercises are continuously adjusted in complexity to promote steady improvement, providing individualized care that is traditionally challenging in group-based or remote settings.
2. Accessibility: By offering a fully virtual platform, the invention ensures access to high-quality speech therapy services for individuals in remote or underserved areas, or for those facing financial barriers to traditional therapy. This accessibility helps to close the gap between the need for speech therapy and the availability of resources.
3. Engagement and Gamification: The platform integrates gamified elements, such as interactive exercises and visual reinforcement, to enhance user engagement. This is especially beneficial for children and users who may find traditional therapy tedious or intimidating.
4. Real-time Feedback and Continuous Monitoring: The system provides immediate feedback on speech and articulation, simulating real-time interactions with a speech therapist. In addition, it allows for remote progress monitoring, enabling speech-language pathologists and caregivers to track improvement and adjust therapy plans as needed, without requiring in-person sessions.
5. Wide Applicability: The invention supports a diverse audience, including children with developmental delays, adults seeking accent reduction, stroke survivors, and individuals with cognitive impairments. It also provides flexibility for self-learners or individuals seeking to improve communication skills for professional development.
6. Cost-effectiveness: By providing a virtual and self-paced alternative to traditional in-person speech therapy, the invention offers a more cost-effective solution, reducing the need for frequent clinic visits while ensuring continuous progress through AI-driven assessments and feedback.

Overall, the invention bridges the gap between accessibility and the need for effective, high-quality speech therapy, leveraging AI to create an innovative and adaptive system that empowers users to overcome communication barriers.

### SUMMARY OF INVENTION

The present invention relates to a comprehensive AI-powered speech therapy platform designed to provide personalized, accessible, and interactive speech therapy services. Utilizing advanced technologies such as Natural Language Processing (NLP), Convolutional Neural Networks (CNNs), and Generative Adversarial Networks (GANs), the platform addresses a wide range of speech disorders, including articulation disorders, stuttering, and voice disorders, by simulating real-life interactions with a speech therapist.

The system operates by initially assessing the user's speech patterns using a combination of NLP and CNNs to evaluate pronunciation, tone, fluency, and facial movements captured via camera. Real-time feedback is provided based on these assessments, allowing users to correct their mistakes immediately. The invention also employs a GAN-based avatar generation model to enhance user engagement by creating realistic virtual avatars that interact with the user during therapy sessions, offering visual and auditory feedback. These avatars are generated by analyzing user-provided images and audio data, which are processed to create lifelike animations and synchronized speech movements.

The invention's backend leverages NLP models to tailor speech therapy exercises to each user's specific needs, ensuring that the therapy sessions evolve as the user's skills improve. The use of CNNs enables the system to perform real-time facial expression analysis to guide users on proper articulation and oral movements during exercises. The integration of GANs further personalizes the therapy experience by animating avatars that mimic human-like expressions, making the sessions more immersive and effective.

Additionally, the platform is designed to be scalable, allowing users to access therapy through web or mobile interfaces. It incorporates a PostgreSQL database to securely store user progress, assessment results, and exercise data, ensuring compliance with data privacy regulations such as HIPAA. Cloud storage is used to store audio and video recordings, enabling users to review their sessions and track their progress over time.

This invention democratizes access to speech therapy by offering a cost-effective, flexible, and personalized solution, catering to a diverse range of users including children with developmental delays, adults seeking accent reduction, and individuals recovering from medical conditions affecting speech.

### BRIEF DESCRIPTION OF DRAWINGS

The invention will be more readily understood by reference to the following description, taken with the accompanying drawings, in which:

FIG. 1—shows a block diagram providing high-level detail of the artificial intelligence architecture, including core application modules, user interface layer, avatar generation model, face expression detection, AI disorder detection audio model, text to image generation model and backend services.

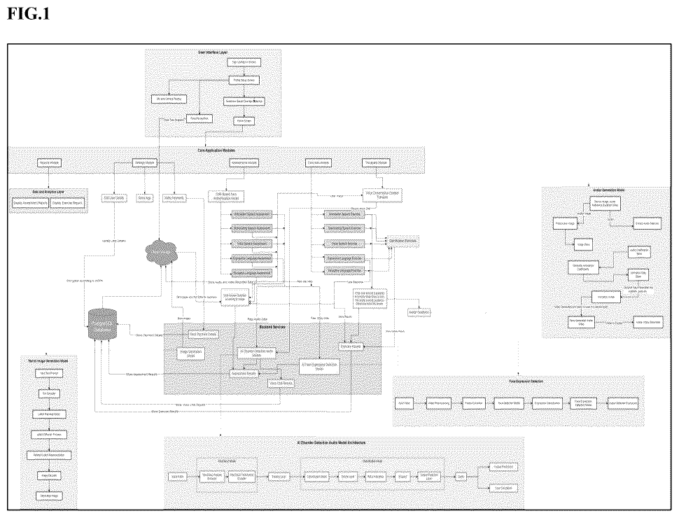

FIG. 2—shows a screenshot of an avatar led AI assessment for speech articulation.

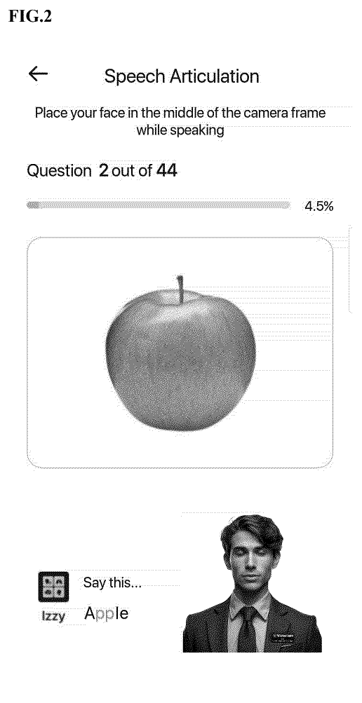

FIG. 3—shows a screenshot of a user answering avatar led AI assessment for speech articulation.

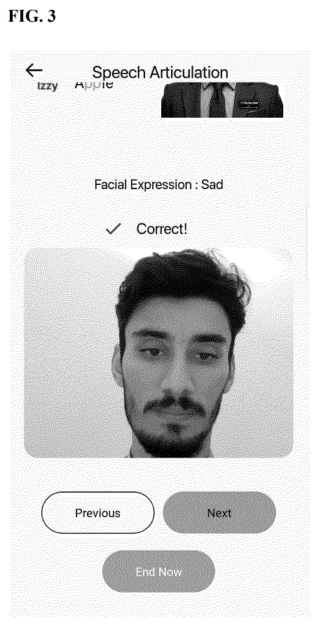

FIG. 4—shows screenshot of result report of speech articulation assessment.

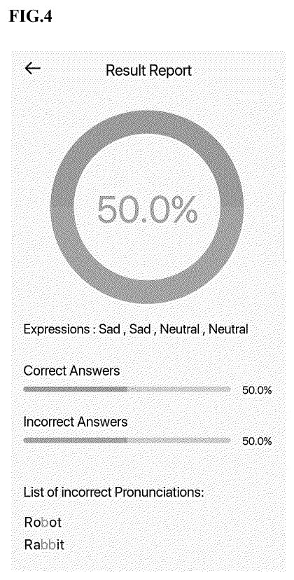

FIG. 5—shows a screenshot of an AI generated assessment for receptive language disorder.

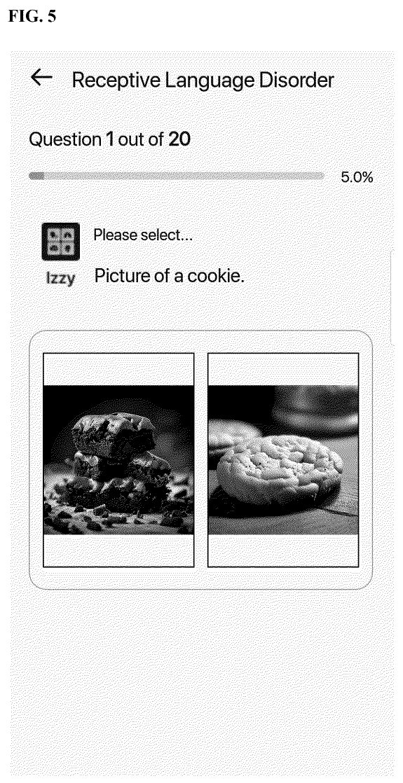

FIG. 6—shows a screenshot of the result of an input into an AI generated assessment for receptive language disorder.

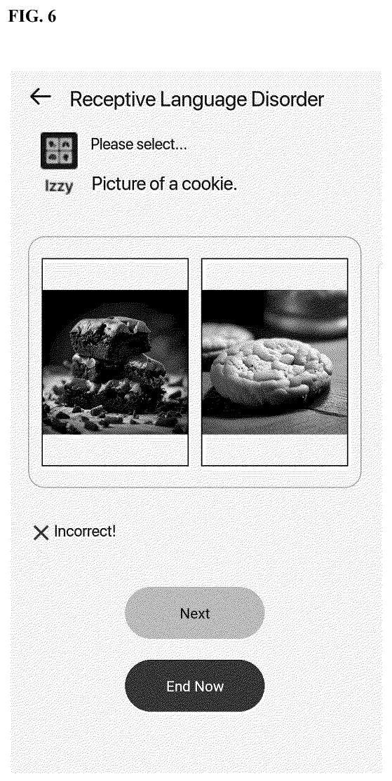

FIG. 7—shows screenshot of result report of receptive language disorder.

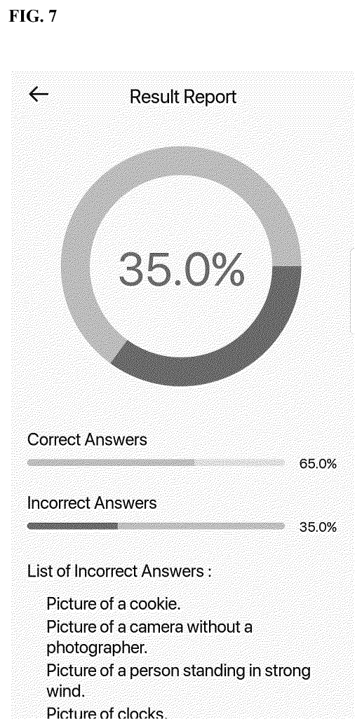

FIG. 8—shows a screenshot of an AI generated assessment for expressive language disorder.

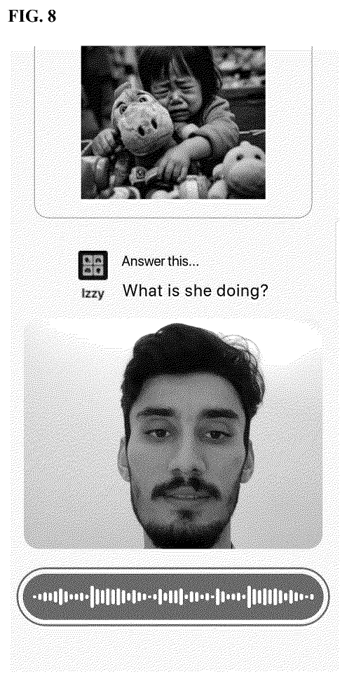

FIG. 9—shows a screenshot of the result of an input into an AI generated assessment for expressive language disorder.

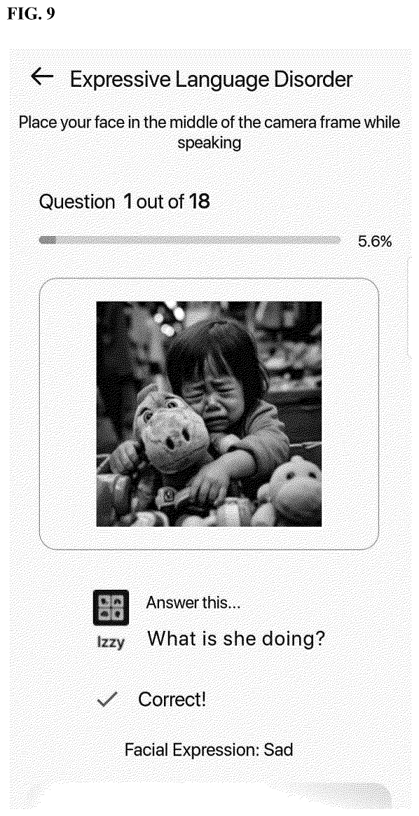

FIG. 10—shows screenshot of result report of expressive language disorder.

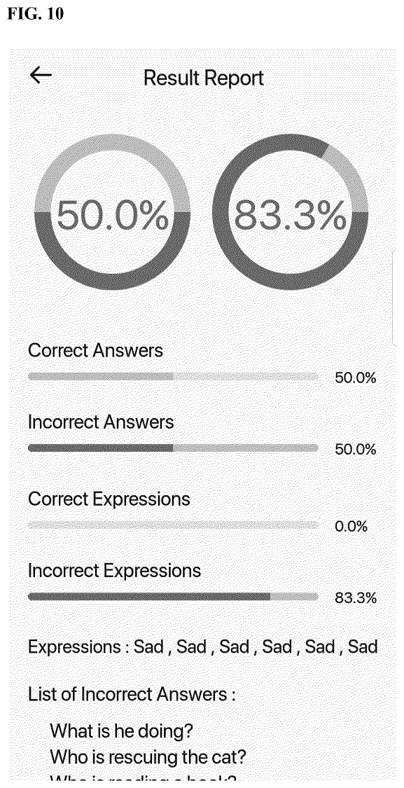

FIG. 11—shows a screenshot of an avatar led AI assessment for voice disorder.

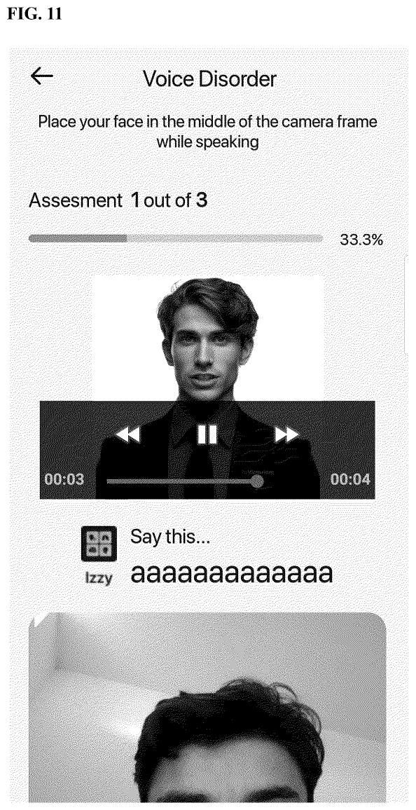

FIG. 12—shows screenshot of result report of voice disorder.

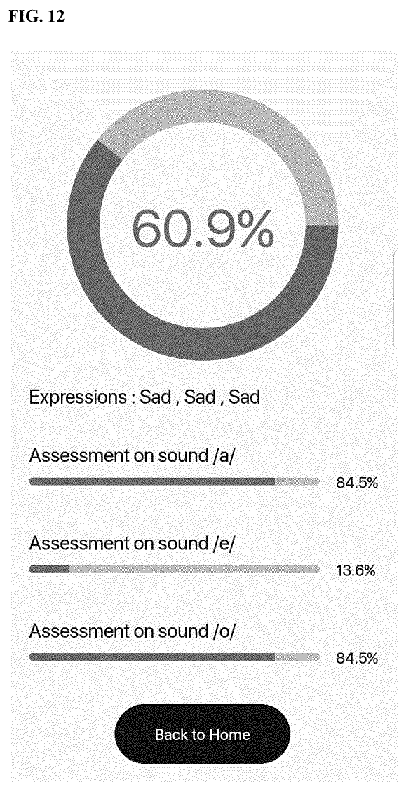

FIG. 13—shows a screenshot of an avatar led AI assessment for stammering/stuttering.

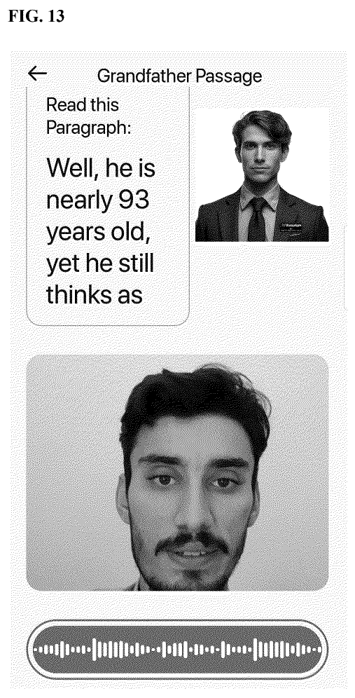

FIG. 14—shows screenshot of result report of stammering.

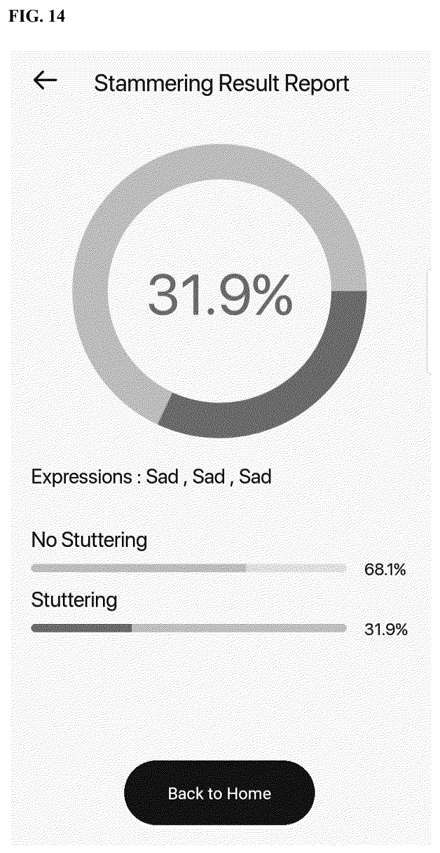

FIG. 15—shows screenshot of conversational avatar and chatbot.

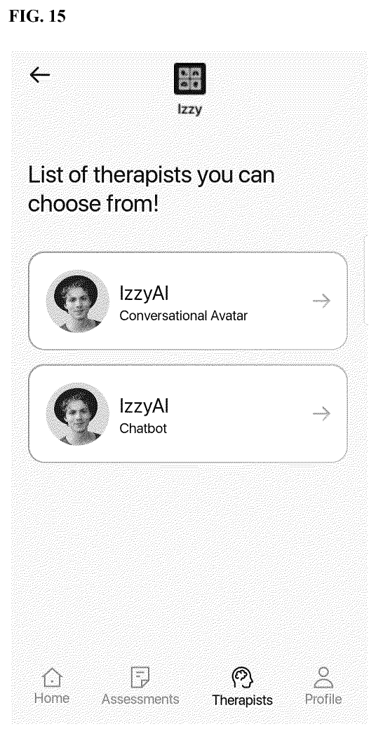

FIG. 16—shows screenshot of AI conversational avatar.

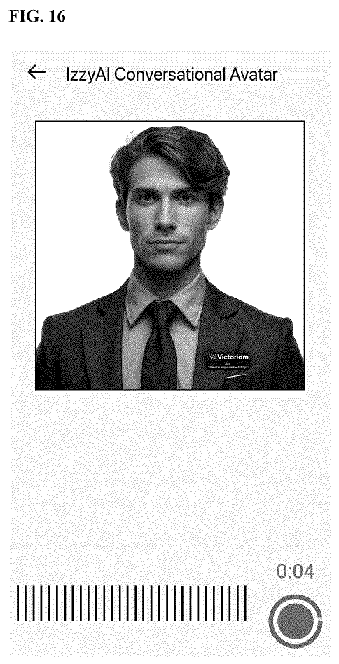

FIG. 17—shows a screenshot of AI chatbot.

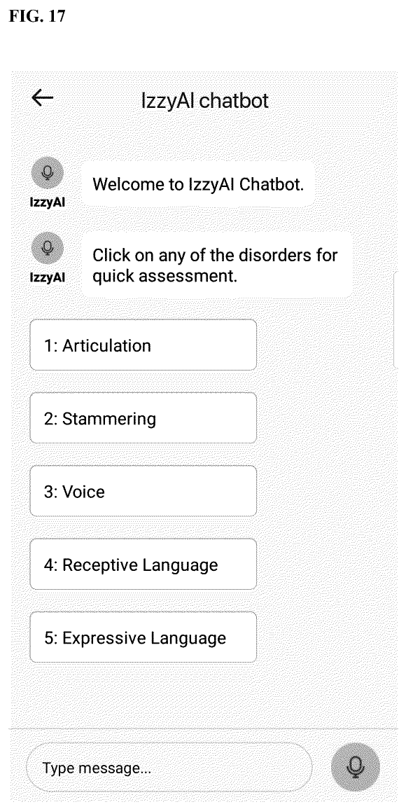

FIG. 18—shows a screenshot of AI chatbot generated language assessment.

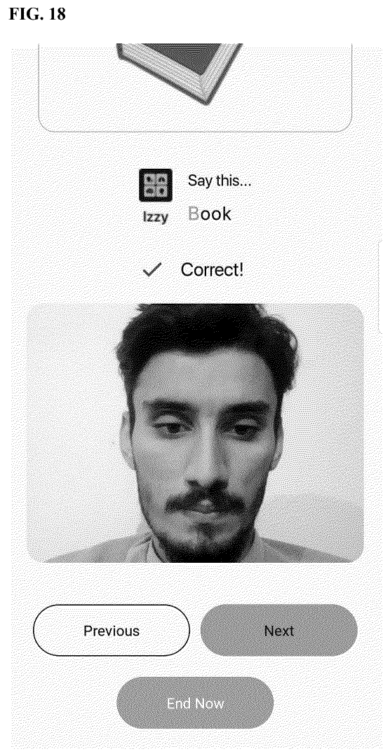

FIG. 19—shows a screenshot of AI chatbot generated stammering assessment result.

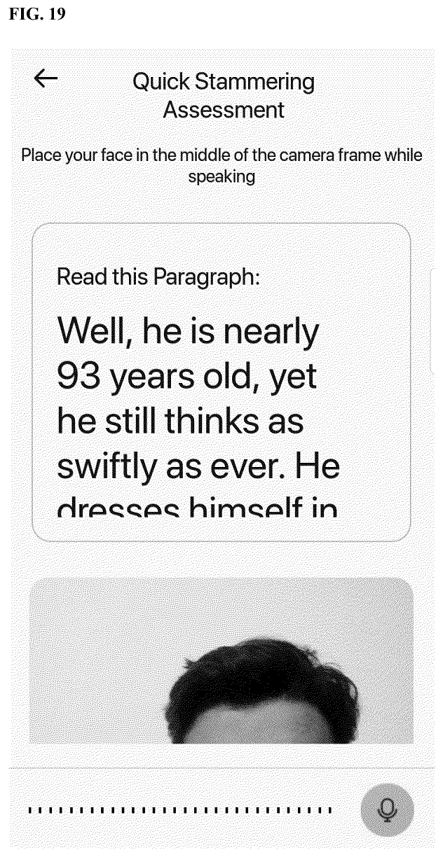

FIG. 20—shows a screenshot of AI chatbot generated voice disorder assessment.

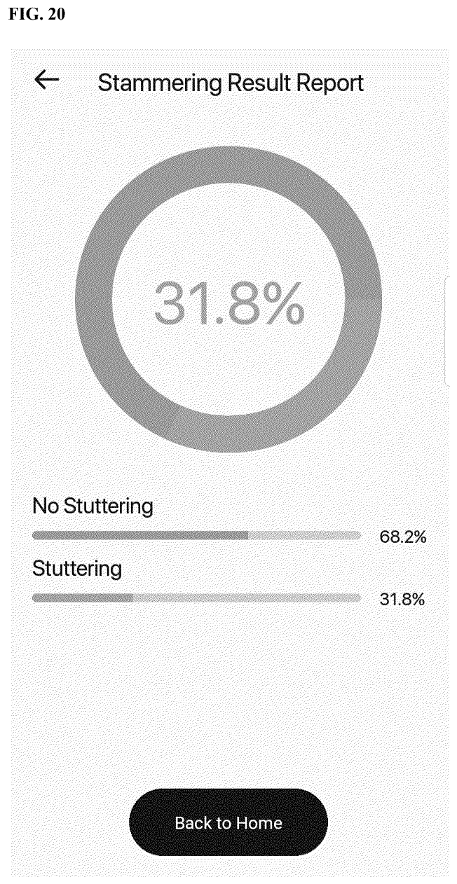

FIG. 21—shows a screenshot of AI chatbot generated voice disorder assessment.

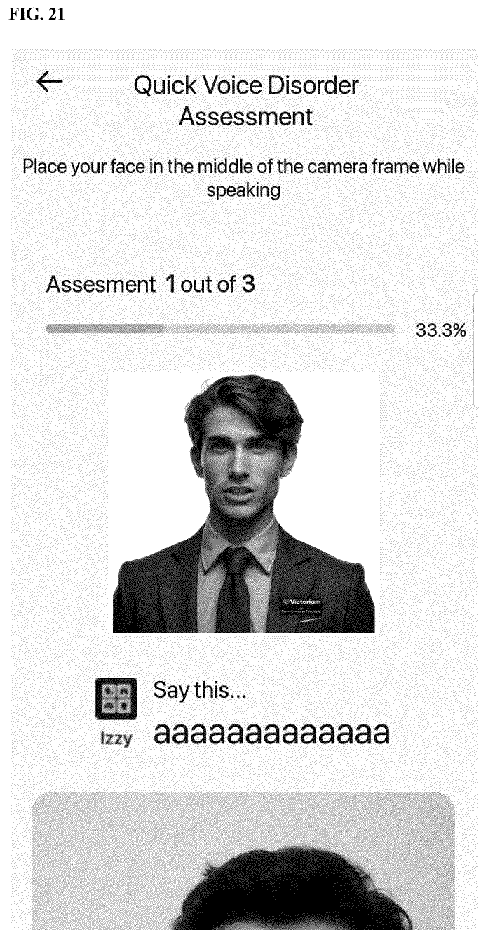

FIG. 22—shows a screenshot of AI chatbot generated voice disorder assessment result report.

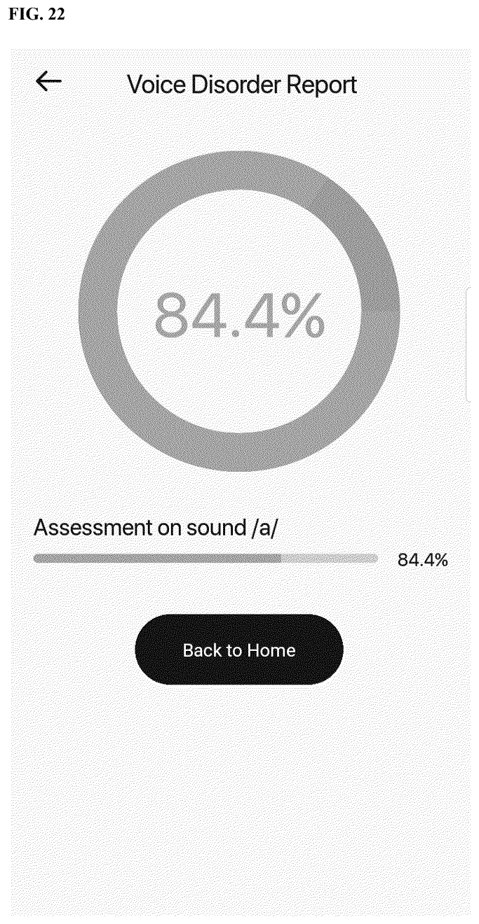

FIG. 23—shows a screenshot of AI generated gamification exercise.

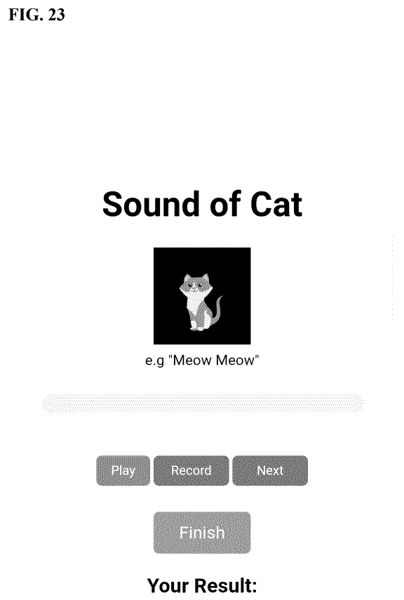

FIG. 24—shows a screenshot of AI generated gamification exercise.

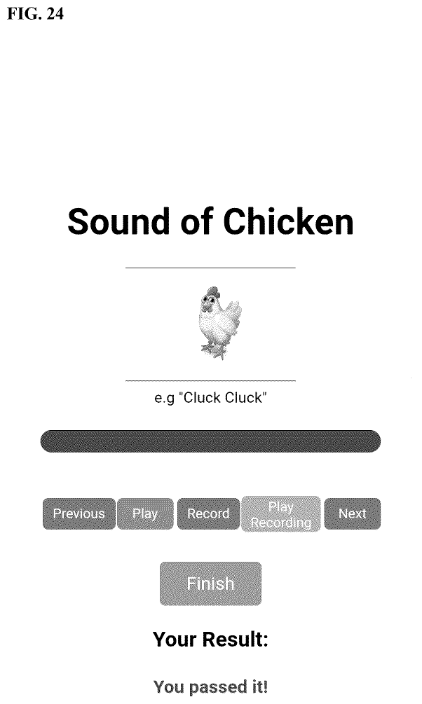

### DETAILED DESCRIPTION OF INVENTION

The invention described herein is an AI-powered speech therapy platform designed to provide personalized and accessible speech and language therapy through the use of advanced technologies, including Natural Language Processing (NLP), Convolutional Neural Networks (CNNs), and Generative Adversarial Networks (GANs). This system is specifically tailored for individuals with speech disorders such as articulation disorders, stammering, and other speech-related challenges. It offers real-time assessments, interactive therapy sessions, and feedback, all delivered through an engaging virtual avatar interface.

This invention is designed to democratize access to speech and language therapy, especially for individuals who lack regular access to a speech therapist due to geographical, financial, or other constraints. The platform provides speech and language assessments, personalized exercises, and real-time feedback in a user-friendly, engaging, and motivating format.

The platform leverages a GAN-based Avatar Generation Model that utilizes images and audio data to create realistic avatars, enhancing user engagement. The avatars are able to mimic human expressions and lip movements, providing both visual and auditory feedback during therapy sessions. The use of avatars helps simulate a real-life interaction with a speech therapist, making the therapy more interactive and personalized.

### Key Components and Functions

1. Natural Language Processing (NLP) for Speech and Language Assessment The system uses advanced NLP techniques to assess and interpret a user's speech patterns. During the assessment phase, NLP models analyze the user's pronunciation, fluency, and sentence construction. The results are used to generate individualized therapy plans. NLP also enables the platform to understand various dialects and accents, providing culturally sensitive therapy. The system is equipped with language models that detect articulation errors, fluency disorders like stammering, and voice disorders.
   The platform evaluates different speech aspects using a variety of assessments, including articulation, fluency, and receptive and expressive language. For example, in articulation therapy, the system performs Sound Distribution analysis using Percentage Consonant Correction (PCC), auditory discrimination, and pronunciation accuracy testing. The expressive language module prompts users to describe images or situations, such as answering questions like “What do you see in this picture?” (Expressive docs), while receptive language exercises involve identifying objects or actions.
2. Convolutional Neural Networks (CNNs) for Visual and Auditory Feedback The system incorporates CNNs to analyze and track facial movements during speech exercises. The user's camera captures real-time facial and oral movements, which are analyzed to provide feedback on articulation and pronunciation. The CNNs detect the user's facial expressions, oral positions, and lip movements, ensuring proper articulation techniques are followed. This is particularly helpful for children and individuals working on improving specific phonemes or sound patterns.
   For example, the CNN module helps users understand how to position their tongue, lips, and teeth during the production of specific sounds. This real-time guidance is critical for articulation therapy, where correct placement of articulators is essential for producing the correct sound.
3. Generative Adversarial Networks (GANs) for Avatar Generation The system uses GANs to create realistic avatars that engage with users during therapy sessions. By processing user-provided images and audio, the GAN model generates avatars that mimic human facial expressions, lip movements, and speech. This creates a more immersive therapy experience, as the avatars are able to express emotions and provide personalized feedback based on the user's performance.
   The avatars are a key feature of the invention, guiding users through assessments and exercises, and adapting their expressions based on user progress. The system also integrates emotional detection into the avatar's behavior, making the experience more human-like and empathetic.
4. Real-Time Feedback and Personalization The platform continuously monitors and adapts to user progress, adjusting therapy exercises and providing real-time feedback. This feature ensures that the therapy is both dynamic and personalized. The system tracks user performance through various exercises, ranging from articulation drills. to expressive and receptive language assessments. For users working on stammering or fluency issues, the system incorporates techniques such as Delayed Auditory Feedback (DAF) and Fluency Shaping.
   The user is presented with personalized assessments based on their performance in previous sessions. For instance, an individual struggling with consonant articulation may be given tailored drills focusing on improving the specific phoneme in question. These drills include repetition exercises, picture-based word association tasks, and guided phonetic placement practices.
5. Gamification and Motivation The invention incorporates gamification elements, such as points, badges, and levels, to motivate users through their therapeutic journey. This adds an element of fun and engagement, especially for younger users and individuals who may otherwise find traditional speech therapy exercises monotonous.
6. Data Storage and Privacy The platform integrates with a PostgreSQL database and cloud storage for securely storing user data, including assessment results, video recordings, and therapy progress. All data is encrypted and stored in compliance with HIPAA and other relevant privacy regulations. This ensures that users' sensitive data, including audio-visual recordings of their sessions, remains protected.

### System Operation and Use

1. User Registration and Onboarding A user starts by registering on the platform through a mobile or web interface. They input key demographic data, including age, language preference, and speech therapy goals. Following registration, an initial assessment is conducted using the platform's NLP-powered tools. This assessment establishes a baseline of the user's speech patterns and identifies areas of improvement.
2. Assessment and Therapy Modules Users are guided by the avatar through a series of exercises based on their specific needs. These exercises include picture-based naming tasks for articulation improvement, fluency exercises for stammering, and expressive language exercises that prompt users to describe scenarios based on visual cues. The system continuously tracks the user's performance, adjusting the difficulty of exercises in real-time.
   For example, in a receptive language task, the user may be asked to identify the object performing a specific action, such as “Point to the one drinking. In expressive language tasks, the user is asked to describe images or answer questions about visual stimuli, such as “What are the kids doing?”.
3. Personalized Feedback and Reports After each session, the platform generates a comprehensive progress report. This report includes feedback on areas of improvement, such as articulation errors or fluency issues, and suggests targeted exercises for the next session. The platform also allows users to review their performance through recorded audio and video files stored securely in the cloud.

### Prior Art Comparison

Numerous apps and platforms currently offer speech therapy tools, some of which integrate AI. Notable examples include Yoodli, TikTalk, and Speech4Good, which offer AI-based tools for fluency shaping, stammering management, and articulation. These apps provide speech practice, feedback, and gamified environments to help users practice at home. However, they often lack a holistic approach that includes both real-time NLP-driven speech analysis and CNN-based visual feedback, making them less effective for users requiring comprehensive guidance on both speech and facial articulation. Additionally, they tend to focus on specific tasks, such as improving fluency or stuttering, but do not offer fully integrated solutions across multiple speech disorders.

Some prior art tools, such as Timlogo and TikTalk, focus on diagnosing pronunciation issues and creating customized exercises but do not offer real-time feedback on facial expressions and oral movements during therapy sessions. While these tools provide customized exercise plans and progress tracking, they do not incorporate GAN-based avatar generation, which enhances engagement and realism during therapy.

Furthermore, many of these tools do not integrate emotional detection in avatars or provide holistic reports that track both speech and facial articulation. Traditional apps such as Articulation Station and Speech Tutor offer static content that users practice with, but they lack dynamic, personalized feedback. This limits their ability to adapt to the user's real-time performance and adjust the exercises accordingly.

### Improvements Over Prior Art

This invention improves upon the prior art by offering a fully integrated system that combines NLP, CNN, and GAN technologies for a more comprehensive and engaging speech therapy experience. Key improvements include:
1. Real-Time Visual and Auditory Feedback: Unlike traditional apps, this system provides real-time feedback on both speech and facial movements using CNNs. This ensures that users receive guidance not only on how they sound but also on how they form words visually, making the therapy more effective.
2. Generative Avatars for Engagement: The GAN-based avatars simulate realistic facial expressions and emotions, providing an engaging experience that feels similar to interacting with a live speech therapist. This level of realism is not found in prior art platforms, which often rely on static or limited visual cues.
3. Personalization through Data-Driven AI: The system continuously adapts to user progress by leveraging NLP models and real-time feedback. The therapy exercises evolve with the user's abilities, ensuring personalized attention throughout their therapy journey. Most prior art focuses on predefined exercise sets without dynamic adaptation based on user performance.
4. Holistic Assessment and Therapy: While many prior art solutions focus on singular speech disorders (e.g., articulation or fluency), this invention provides a full suite of assessments and therapy options, including articulation, stammering, receptive and expressive language, and voice disorders. This comprehensive approach allows users to address multiple aspects of speech and language in a single platform.

### BEST MODE OF CARRYING OUT THE INVENTION

The best mode for carrying out this invention is through a mobile and web application that users can access on devices equipped with cameras and microphones. Users interact with AI-driven avatars that provide personalized, real-time feedback on speech and facial movements. The system is powered by NLP, CNNs, and GANs, allowing for dynamic adjustment of therapy exercises to match the user's specific needs. This comprehensive solution is accessible, engaging, and tailored for individuals of all ages with varying speech therapy requirements.

This invention stands apart from existing tools by offering an engaging, holistic, and adaptive approach to speech therapy, designed to provide the highest level of personalized care and support.

### List of AI Models

The system utilizes several distinct AI models to perform various functions related to speech therapy, avatar generation, and user interaction. Here's a breakdown of the different models being used:

### Natural Language Processing (NLP) Models

Function: The NLP models are responsible for analyzing user speech patterns, including fluency, articulation, and sentence structure. These models assess the user's language comprehension, speech accuracy, and general communication skills.
Modules:
   Voice Speech Assessment: This module evaluates the clarity, fluency, and overall quality of the user's speech.
   Expressive and Receptive Language Assessments: These assessments test the user's ability to generate (expressive) and understand (receptive) language by interacting with the system.
Example Tasks:
   Detecting mispronunciations.
   Understanding sentence structure and grammar errors.
   Adjusting the difficulty of exercises based on language proficiency.

### Convolutional Neural Network (CNN) Based Face and Expression Detection Models

Function: CNN models are used for analyzing real-time video input to track facial movements and expressions. These models play a critical role in guiding the user through articulation exercises by providing real-time feedback on lip, tongue, and jaw movements.
Modules:
   Face Expression Detection: Detects and analyzes facial expressions, which are crucial in determining user engagement and the correctness of articulation exercises.
   Face Recognition: Identifies the user and tracks their progress based on visual input.
Example Tasks:
   Providing visual feedback on mouth shapes during speech exercises.
   Correcting facial movements for accurate phoneme production.
   Emotion detection to adapt the avatar's behavior based on the user's mood.

### Generative Adversarial Networks (GANs) for Avatar Generation

Function: GANs are employed to create dynamic and personalized avatars that engage with users during therapy sessions. These avatars mimic human facial expressions, lip movements, and speech, creating a realistic and interactive environment.
Modules:
   Avatar Generation Model: This model processes input images and audio to create a virtual avatar. The avatar's facial expressions and lip movements are synchronized with the user's speech.
   Animation Data Generation: Converts speech and facial analysis data into animations for the avatar, ensuring that it responds accurately to the user's speech and emotions.
Example Tasks:
   Generating a customized avatar that interacts with the user.
   Mimicking the user's facial expressions to create a personalized engagement.
   Lip-syncing the avatar's mouth movements to match the user's speech.

### AI Disorder Detection Audio Model

Function: This model analyzes audio input to detect specific speech disorders such as articulation problems, stuttering, or voice disorders. It processes the user's speech to identify abnormalities and suggest appropriate therapeutic exercises.
Modules:
   Articulation Speech Assessment: Analyzes user speech for articulation disorders, providing targeted exercises to improve pronunciation and clarity.
   Stammering Speech Assessment: Specifically designed to detect and address stammering, offering exercises that enhance fluency.
Example Tasks:
   Detecting and diagnosing specific speech disorders based on audio input.
   Recommending personalized exercises based on detected speech disorders.

### Text-to-Image Generation Model

Function: This model is responsible for creating visual representations based on textual input. It likely helps generate images or animations that enhance the user's interaction with the system, such as displaying exercises or educational content in visual form.
Modules:
   Latent Representation Processing: Converts text input into a latent representation that can be transformed into an image.
   Image Decoder: Transforms the latent representation into an image that can be displayed to the user.
Example Tasks:
   Generating images that correspond to specific words or phrases during language exercises.
   Creating visual aids to assist users in understanding speech or language concepts.

### AI Face Expression Detection Model

Function: Similar to the CNN-based model, this module is focused on detecting and classifying facial expressions. However, it may be more specialized in identifying specific emotional cues, such as frustration or satisfaction, which can help adjust therapy exercises or interactions.
Modules:
   Expression Classification: Detects subtle facial cues to understand the user's emotional state.
   Face Detection and Frame Extraction: Extracts frames from video input to analyze the user's facial expressions over time.
Example Tasks:
   Adjusting the avatar's behavior based on detected emotions.
   Tracking the user's level of engagement and making real-time adjustments to the session.

### AI Face and Emotion Detection

Function: This model is used to detect the user's emotional responses during therapy, such as frustration or joy, and adapt the therapy accordingly. It ensures the user is engaged and receiving the right level of challenge.
Modules:
   Emotion Detection Model: Analyzes facial expressions and speech patterns to determine the user's emotional state.
   Feedback Loop: Adjusts the difficulty of tasks or the avatar's interaction based on detected emotions.
Example Tasks:
   Adjusting the difficulty of tasks when frustration is detected.
   Adapting the avatar's responses to encourage or console the user.

### Backend Services and Data Storage

Function: This layer is crucial for securely storing and retrieving user data, such as session recordings, assessments, and exercise results. It manages the integration of cloud storage and database services.
Modules:
   Database for User Data: Stores detailed records of user performance, including audio, video, and assessment data.
   Cloud Storage: Stores user recordings, avatars, and session data while ensuring privacy compliance (e.g., HIPAA).
Example Tasks:
   Retrieving stored session recordings for progress tracking.
   Storing assessment results to generate personalized therapy plans.

### Programming Languages

The invention is developed primarily using Python, a versatile and widely adopted programming language in the field of artificial intelligence and machine learning. Python provides a rich ecosystem of libraries and frameworks, making it well-suited for implementing complex AI models and handling various aspects of the image generation pipeline. Key libraries utilized include:

### Backend Services and API Development

Programming Language: Python and/or JavaScript (Node.js)
Frameworks:
   Flask or Django (Python-based web frameworks)
   Express.js (for Node.js backend)·
Functions:
   These languages and frameworks would be used for handling the backend services, managing API calls, and connecting with various AI models. Python is particularly well-suited due to its extensive library support for AI/ML tasks, while Node.js can be used for handling high-performance, asynchronous operations on the server-side.
Example Tasks:
   Integrating NLP, CNN, and GAN models into a web application.
   Managing user authentication and API requests.
   Handling database queries and storing session data.

### NLP Models

Programming Language: Python
Libraries:
   spaCy
   NLTK (Natural Language Toolkit)
   Hugging Face Transformers
Functions:
   Python is typically used for building and deploying NLP models. Libraries like spaCy and NLTK are popular for language processing, while Hugging Face Transformers would be used for more advanced NLP tasks like text classification, language understanding, and generating responses.
Example Tasks:
   Speech analysis to detect fluency and articulation errors.
   Processing text-based input from the user and generating personalized feedback.
   Building language models to detect different accents and dialects.

### Convolutional Neural Network (CNN) Models

Programming Language: Python
Libraries/Frameworks:
   TensorFlow
   Keras
PyTorch
Functions:
   CNN models for face detection, facial movement analysis, and real-time video processing are typically built using Python along with deep learning frameworks such as TensorFlow or PyTorch. These libraries provide powerful tools for building, training, and deploying CNN models.
Example Tasks:
   Real-time analysis of user's facial expressions.
   Tracking lip movements and oral positioning during speech exercises.
   Training CNN models for specific facial and articulation recognition tasks.

### Generative Adversarial Networks (GANs) for Avatar Generation

Programming Language: Python
Libraries/Frameworks:
   PyTorch (preferred for GANs)·
   TensorFlow
   Keras (as a high-level API for TensorFlow)·
Functions:
   GANs for avatar generation are often implemented in Python using PyTorch or TensorFlow. These frameworks allow for constructing and training GAN models to generate lifelike avatars based on input images and audio.
Example Tasks:
   Generating avatars that mimic the user's facial expressions.
   Training the GAN to synchronize lip movements with the user's speech in real-time.
   Personalizing avatars for each user's therapy session.

### Text-to-Image Generation Model

Programming Language: Python
Libraries/Frameworks:
   OpenAI's CLIP
   DALL E (or custom-built models using GANs)·
Functions:
   Text-to-image generation models are typically written in Python, using state-of-the-art libraries like CLIP or DALL E for generating images from textual descriptions. These libraries can be fine-tuned to create visual aids during therapy sessions.
Example Tasks:
   Generating visual representations of specific words or phrases.
   Creating visual cues or animated content based on user input during therapy.

### AI Face and Emotion Detection

Programming Language: Python
Libraries:
   OpenCV (for real-time video analysis)·
   Dlib (for facial landmark detection)
   TensorFlow/Keras/PyTorch (for training emotion detection models)·
Functions:
   Python, along with libraries like OpenCV and Dlib, can be used to detect and analyze facial features and emotions. TensorFlow and PyTorch would be used for training deep learning models for emotional detection and expression analysis.
Example Tasks:
   Detecting user emotions such as frustration or satisfaction based on facial cues.
   Adjusting the avatar or therapy exercises dynamically based on the user's emotional state.

### Frontend User Interface

Programming Languages:
   JavaScript (for client-side logic)·
   HTML5/CSS3 (for structuring and styling web pages)·
   TypeScript (for enhanced JS development)
Frameworks:
   React.js (for building interactive user interfaces)
   Vue.js or Angular (alternatives to React.js)
Functions:
   React.js (or similar frameworks like Vue.js) would be used to build a responsive and interactive user interface for users to interact with the therapy platform. JavaScript enables dynamic content loading, real-time interactions, and seamless user experience on web and mobile platforms.
Example Tasks:
   Creating the user dashboard for accessing therapy sessions.
   Integrating real-time feedback mechanisms using WebSockets or API calls.
   Displaying avatars and tracking user progress through the UI.

### Data Storage and Backend Management

Programming Language: SQL (for database queries) and Python/JavaScript
Databases:
   PostgreSQL (for structured data)
   MongoDB (if NoSQL storage is needed)·
Functions:
   Managing user data, session recordings, therapy progress, and assessment results. SQL databases like PostgreSQL are ideal for structured storage, while MongoDB could be used for storing less structured data (e.g., logs or interaction histories).
Example Tasks:
   Storing and querying therapy session data.
   Securely handling user authentication and data encryption.
   Managing data retrieval for generating reports and tracking user progress.

### Cloud Services and API Integration

Programming Languages:
   Python (for API and cloud-based services)
   JavaScript/Node.js (for real-time API calls and serverless functions)·
Cloud Providers:
   AWS Lambda or Google Cloud Functions (for serverless processing)
   AWS S3 or Google Cloud Storage (for storing large media files)·
Functions:
   Cloud services are crucial for securely storing large datasets (e.g., video/audio files from therapy sessions) and enabling serverless computations.
Example Tasks:
   Storing user recordings and session data in cloud-based storage.
   Integrating third-party APIs for additional features such as transcription services.

1: A method for providing AI-based personalized speech and language therapy, the method comprising:
(a) utilizing Natural Language Processing (NLP) models to assess a user's speech patterns, including pronunciation, fluency, and sentence construction.
(b) analyzing real-time video input using Convolutional Neural Networks (CNNs) to track facial expressions and oral movements during speech exercises.
(c) generating a virtual avatar using Generative Adversarial Networks (GANs), wherein the avatar mimics human facial expressions, lip movements, and speech to engage the user in therapy.
(d) providing real-time feedback to the user based on speech and visual data captured, the feedback including guidance on articulation, fluency, and pronunciation.
(e) adjusting therapy exercises dynamically based on user performance and progress tracked during therapy sessions.
(f) storing user data, including assessment results and session recordings, in a secure database for progress tracking and data privacy compliance.

2: A system for AI-powered speech therapy, the system comprising:
(a) a Natural Language Processing (NLP) module configured to assess speech patterns including articulation, fluency, and sentence construction.
(b) a Convolutional Neural Network (CNN) module configured to analyze real-time facial movements and provide visual feedback on oral positioning and articulation.
(c) a Generative Adversarial Network (GAN) module configured to generate avatars that mimic human expressions and interact with users during therapy.
(d) a real-time feedback system configured to dynamically adjust therapy exercises based on user performance, providing feedback on both speech and facial movements.
(e) a data storage and encryption module for securely storing user assessments, session recordings, and progress data, ensuring compliance with privacy regulations.
(f) a user interface for delivering personalized therapy exercises and facilitating interaction between the user and the avatar.

3: A computer-implemented method for providing speech and language therapy via a web or mobile application, comprising:
(a) analyzing user speech through Natural Language Processing (NLP) to detect articulation errors, fluency disorders, and voice issues.
(b) tracking facial expressions and oral movements in real time using Convolutional Neural Networks (CNNs) during therapy exercises.
(c) creating a Generative Adversarial Network (GAN)-generated avatar that delivers personalized feedback to users based on their speech and visual data.
(d) adjusting the difficulty of speech therapy exercises dynamically based on user performance data.
(e) providing real-time, personalized feedback on articulation and fluency, including suggestions for improvement.
(f) securely storing user performance data in compliance with HIPAA and other privacy regulations.

4: The method of claim 1, further comprising:
(a) generating user-specific therapy plans based on an initial speech assessment conducted by the NLP models, wherein the plans are adjusted in real time based on user progress.

5: The method of claim 1, wherein the CNN module tracks the user's tongue, lips, and teeth positioning in real time, and provides visual guidance for correcting articulation errors.

6: The method of claim 1, wherein the GAN-generated avatar adapts its facial expressions and tone of voice based on user performance and emotional engagement during the therapy session.

7: The method of claim 1, further comprising:
(a) integrating Delayed Auditory Feedback (DAF) for users with fluency disorders, wherein the user's speech is played back with a configurable delay to assist in fluency shaping.

8: The system of claim 2, wherein the NLP module is configured to detect multiple languages and dialects, allowing the system to provide culturally sensitive therapy exercises tailored to the user's linguistic background.

9: The system of claim 2, further comprising:
(a) a gamification module that tracks user progress through therapy exercises, rewards users with badges and levels, and provides visual feedback on improvements in articulation and fluency.

10: The system of claim 2, wherein the real-time feedback system uses both audio and visual cues to guide the user in correcting speech and articulation issues, including facial expression recognition and correction for accurate phoneme production.

11: The method of claim 3, further comprising:
(a) providing users with the ability to replay their therapy sessions through stored recordings, allowing them to review their performance and monitor their progress over time.

12: The method of claim 3, wherein the GAN-generated avatar is capable of mimicking user-specific facial expressions, allowing for a more personalized interaction during the therapy session.

13: The method of claim 3, further comprising:
(a) using facial expression detection to analyze the user's emotional engagement and adjust the difficulty or nature of therapy exercises in response to the detected emotional state.
